(19) United States
(12) Patent Application Publication
(10) Pub. No.: US 2026/0370675 A1
(43) Pub. Date: Nov. 19, 2026

(54) CYBERSECURITY ASSESSMENT SYSTEM WITH AUTOMATED CONTROL MAPPING, AI-ASSISTED GUIDANCE GENERATION, AND PROGRESSIVE COMPLIANCE DOCUMENT ASSEMBLY

(71) Applicant: UNIVERSITY OF SOUTH FLORIDA, Tampa, FL (US)

(72) Inventors: Manish AGRAWAL, Tampa, FL (US); Emeka Jerrell OKAMMOR, Tampa, FL (US); Emilio Frank SALABARRIA, Tampa, FL (US); Bryan Jon LANGLEY, Tampa, FL (US); Kireet AGRAWAL, Tampa, FL (US); Dat Ba LE, Tampa, FL (US); Ernest Ferraresso, Tampa, FL (US)

(21) Appl. No.: 19/678,016

(22) Filed: May 14, 2026

Related U.S. Application Data
(60) Provisional application No. 63/805,529, filed on May 14, 2025.

(51) Int. Cl. H04L 9/40

(52) U.S. Cl. CPC H04L 63/1433

(57) ABSTRACT

A cybersecurity assessment system presents one or more assessment items organized across functional domains of a cybersecurity framework to an organization and receives maturity-scale responses. For each deficient response, the system retrieves corresponding controls from a security control library using a control item identifier and transmits a guidance summary comprising a plain-language interpretation of those controls generated by one or more large language models and approved through human-in-the-loop review. The system computes an aggregate maturity score and functional domain sub-scores and outputs a completion report. Additional functions include progressive compliance document generation based on plan-completion questions, cross-organizational benchmarking using organizational metadata, anonymized sector-segmented maturity profiling, threat intelligence integration with prioritized remediation advisories, NICE workforce framework role mapping, job description template generation, longitudinal progress tracking, and comparative feedback reporting.

### CROSS-REFERENCE TO RELATED APPLICATIONS

This application claims the benefit of U.S. Provisional Application No. 63/805,529, filed May 14, 2025, the entire disclosure of which is incorporated herein by reference.

### BACKGROUND

The present disclosure relates generally to cybersecurity assessment systems and, more particularly, to systems and methods for automated mapping of cybersecurity framework assessment items to security control library entries, artificial intelligence assisted guidance generation, and progressive compliance document assembly.

Organizations across critical infrastructure sectors assess and manage their cybersecurity readiness using recognized cybersecurity frameworks. For example, the National Institute of Standards and Technology (NIST) Cybersecurity Framework (CSF) 2.0 provides a structured self-assessment instrument comprising numerous assessment items organized across functional domains. Translating assessment results into remediation plans may involve navigating security control libraries (such as NIST Special Publication 800-53) that may span hundreds of pages of technical specifications, and correlating individual assessment items to applicable controls, workforce requirements, and available assistance resources. Existing governance, risk, and compliance (GRC) platforms and framework assessment tools may employ manual mapping or static templates for this purpose.

### BRIEF SUMMARY

In one aspect, a method comprises: presenting one or more assessment items for an organization, the assessment items organized across one or more functional domains of a cybersecurity assessment framework, each assessment item corresponding to a cybersecurity framework control item and associated with a control item identifier; receiving one or more responses to the assessment items including compliant responses and deficient responses; for each deficient response, retrieving one or more corresponding controls from a security control library using the control item identifier; for each deficient response, transmitting a guidance summary comprising a human-readable interpretation of the corresponding controls; computing an aggregate maturity score and one or more functional domain sub-scores by mapping each response to a numerical value on a multi-level maturity scale; and outputting a completion report comprising the aggregate maturity score, the functional domain sub-scores, and the guidance summary for each deficient response.

In some embodiments, the guidance summary may be generated by processing the corresponding controls through one or more large language models using engineered prompts to generate a candidate plain-language summary, receiving an approval, rejection, or modification of the candidate summary through a review interface, and designating the approved or modified summary as the guidance summary for transmission to the organization. In some embodiments, the method may further comprise receiving a user selection of a term or phrase within the assessment items or guidance summaries and generating, using the one or more large language models, a plain-language explanation of the selected term or phrase.

In some embodiments, the method may further comprise collecting organizational metadata comprising at least a sector classification, an organization size, and a designation indicating whether a chief information officer or a chief information security officer is present, and generating one or more cross-organizational benchmarking outputs using the organizational metadata as segmentation variables. The method may further comprise aggregating assessment data from a plurality of organizations, anonymizing the aggregated assessment data, and generating a maturity profile segmented by critical infrastructure sector.

In some embodiments, the method may further comprise receiving external threat intelligence data comprising one or more indicators of compromise associated with one or more threat actors, cross-referencing the indicators of compromise with deficient responses from one or more organizations, and generating one or more prioritized remediation advisories identifying one or more sectors exhibiting exposure to the one or more threat actors.

In some embodiments, the method may further comprise presenting, alongside each assessment item and the corresponding guidance summary, one or more plan-completion questions, receiving one or more user responses to the plan-completion questions, and progressively generating a compliance document based on the user responses, the compliance document comprising at least one of an incident response plan, a governance plan, or a recovery plan. The assessment items, corresponding guidance summaries, and corresponding plan-completion questions may be displayed in a side-by-side modular interface, and the compliance document may be made available for download as the user advances through each module of the side-by-side modular interface.

In some embodiments, the method may further comprise, for each deficient response, mapping the deficient response to one or more National Initiative for Cybersecurity Education (NICE) workforce framework roles associated with skills or capabilities for remediating the deficiency, and generating a job description template based on the one or more NICE workforce framework roles.

In some embodiments, the method may further comprise retrieving one or more prior aggregate maturity scores and one or more prior functional domain sub-scores from one or more prior assessment cycles, comparing the aggregate maturity score and the functional domain sub-scores to the prior scores, and generating a longitudinal progress report reflecting a change in cybersecurity maturity of the organization across the one or more prior assessment cycles.

In some embodiments, the method may further comprise applying, to one or more computer systems or networks of the organization, one or more security improvements based on the guidance summaries, wherein applying the one or more security improvements comprises at least one of: configuring an access control, deploying a monitoring tool, updating a security policy, implementing an encryption protocol, applying a security patch, or modifying a network configuration. After applying the one or more security improvements, the method may further comprise re-presenting the one or more assessment items to the organization, receiving updated responses, computing an updated aggregate maturity score and updated functional domain sub-scores, and generating a comparative feedback report reflecting a change in cybersecurity maturity of the organization between the aggregate maturity score and the updated aggregate maturity score.

In another aspect, a computer readable medium stores executable instructions to: present one or more assessment items for an organization organized across one or more functional domains of a cybersecurity assessment framework, each assessment item corresponding to a cybersecurity framework control item and associated with a control item identifier; receive one or more responses to the assessment items including compliant responses and deficient responses; for each deficient response, retrieve one or more corresponding controls from a security control library using the control item identifier; for each deficient response, transmit a guidance summary comprising a human-readable interpretation of the corresponding controls; compute an aggregate maturity score and one or more functional domain sub-scores by mapping each response to a numerical value on a multi-level maturity scale; and output a completion report comprising the aggregate maturity score, the functional domain sub-scores, and the guidance summary for each deficient response.

In yet another aspect, a system comprises a processor and a memory coupled to the processor and storing instructions executable by the processor to: present one or more assessment items for an organization organized across one or more functional domains of a cybersecurity assessment framework, each assessment item corresponding to a cybersecurity framework control item and associated with a control item identifier; receive one or more responses to the assessment items including compliant responses and deficient responses; for each deficient response, retrieve one or more corresponding controls from a security control library using the control item identifier; for each deficient response, transmit a guidance summary comprising a human-readable interpretation of the corresponding controls; compute an aggregate maturity score and one or more functional domain sub-scores by mapping each response to a numerical value on a multi-level maturity scale; and output a completion report comprising the aggregate maturity score, the functional domain sub-scores, and the guidance summary for each deficient response.

### BRIEF DESCRIPTION OF THE DRAWINGS

FIG. 1 illustrates an example cybersecurity assessment environment, in accordance with some aspects of the technology;

FIG. 2 illustrates an example server-side cybersecurity assessment system and client-side cybersecurity assessment system in expanded detail, in accordance with some aspects of the technology;

FIG. 3 illustrates an example computer, in accordance with some aspects of the technology;

FIG. 4 illustrates an example method for automated cybersecurity risk assessment and resource mapping, in accordance with some aspects of the technology;

FIG. 5 illustrates an example method for progressive compliance document generation and workforce gap mapping, in accordance with some aspects of the technology; and

FIG. 6 illustrates an example method for cross-organizational benchmarking, threat intelligence integration, and longitudinal maturity tracking, in accordance with some aspects of the technology.

### DETAILED DESCRIPTION

The present disclosure relates generally to cybersecurity assessment systems and, more particularly, to systems and methods for automated mapping of cybersecurity framework assessment items to security control library entries, artificial intelligence assisted guidance generation with human-in-the-loop review, and progressive compliance document assembly for organizations seeking to evaluate and improve their cybersecurity posture.

Aspects of the present disclosure provide a cybersecurity assessment system that automates the mapping of framework assessment items to security control library entries, generates AI-powered plain-language guidance summaries subject to human-in-the-loop review, progressively assembles compliance documents as users advance through assessment modules, and produces cross-organizational benchmarking analytics from aggregated, anonymized assessment data. The system may further map deficient assessment items to workforce framework roles, generate job description templates, and cross-reference external threat intelligence with organizational assessment gaps to produce prioritized remediation advisories.

The following detailed description references the accompanying drawings, which illustrate specific embodiments of the present disclosure. Other embodiments having different structures and operations do not depart from the scope of the present disclosure. Like reference numerals may refer to the same or similar elements throughout the several views of the drawings.

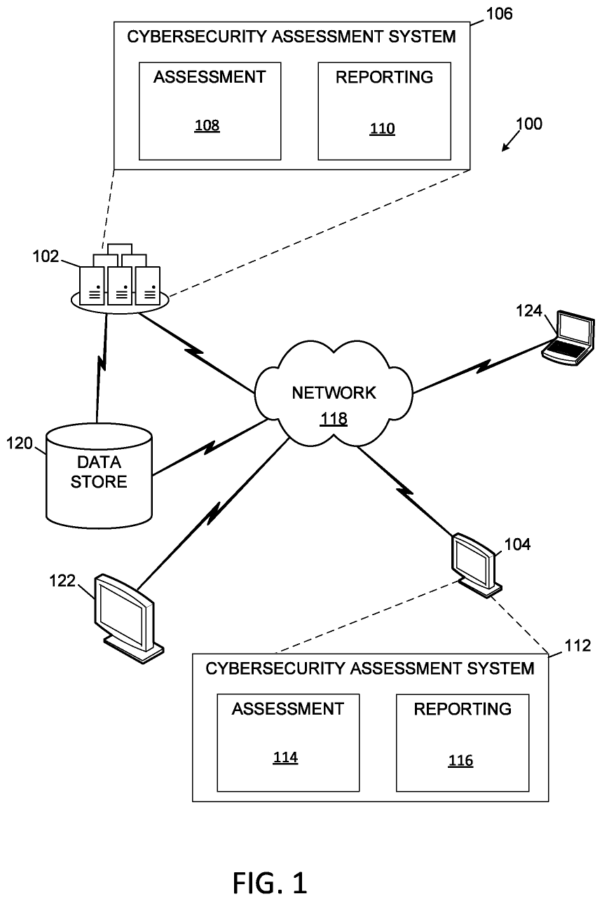

FIG. 1 is a block diagram of an example cybersecurity assessment environment 100 in accordance with one or more aspects of the present disclosure. The cybersecurity assessment environment 100 may include a server system 102, a network 118, a data store 120, a plurality of client devices (for example, a first client device 104, a second client device 122, and a third client device 124), a first cybersecurity assessment system 106 executing on the server system 102, and a second cybersecurity assessment system 112 executing on the first client device 104.

In some embodiments, the first cybersecurity assessment system 106 may be organized into four functional layers: an assessment layer, a data layer, a mapping logic layer, and a presentation layer. The assessment layer may provide the user-facing interface through which organizational users may respond to assessment items of a cybersecurity assessment framework. The data layer may aggregate assessment responses and organizational metadata, may perform anonymization operations, and may expose a queryable dataset supporting analytics and benchmarking. The mapping logic layer may encompass AI-driven processing components, including, for example, automated crosswalks from assessment items to security control library entries, AI-based guidance summary generation, and workforce framework mapping. The presentation layer may govern the user experience of the web-based portal, including, for example, navigation flow, module layout, score display, and delivery of output artifacts such as completion reports and compliance documents. In some embodiments, the presentation layer may minimize user interactions required to reach core assessment content. For example, the presentation layer may route a user directly to the active assessment upon login. In some embodiments, the presentation layer may be implemented on a cloud computing infrastructure operated by a certified technology partner. The functions described above may be distributed across more or fewer computational tiers, and individual functions may be co-located or distributed across separate services, microservices, or modules.

The server system 102 may be any computing infrastructure (for example, a server cluster, cloud-based data center, or other computing hardware) configured to host and execute software applications. In some embodiments, the server system 102 may be deployed in alignment with applicable security and compliance frameworks for cloud-hosted government-facing services, such as FedRAMP, StateRAMP, or a state-level risk and authorization management program. The server system 102 may provide the compute foundation on which the first cybersecurity assessment system 106 executes. The server system 102 may itself constitute one or more computer systems within the meaning of computer systems or networks of an organization, and security improvements may be applied to the server system 102 based on guidance generated by the first cybersecurity assessment system 106.

The network 118 may be any communication network or combination of networks (for example, a LAN, WAN, the Internet, or a cloud or virtual network) supporting communication among the server system 102, the data store 120, and the plurality of client devices 104, 122, and 124. In some embodiments, external threat intelligence data (for example, threat bulletins and indicators of compromise) may arrive at the first cybersecurity assessment system 106 via the network 118. The network 118 may itself constitute a network within the meaning of computer systems or networks of an organization, and security improvements may be applied to the network 118 based on guidance summaries and completion reports generated by the first cybersecurity assessment system 106.

The data store 120 may be one or more databases, storage arrays, networked file systems, object storage repositories, or other data storage systems. In some embodiments, assessment response records, organizational metadata, and guidance summaries may be stored in relational database tables, while generated compliance documents (for example, a completion report or an incident response plan) may be stored as files in object storage accessible via time-limited URLs. The data store 120 may store, for each organization, assessment responses, organizational metadata, guidance summaries, security control library content and pre-seeded mapping tables, aggregate maturity scores, functional domain sub-scores, domain completion percentages, prior aggregate maturity scores and domain sub-scores from prior assessment cycles, compliance documents, milestone lists, and document panel file collections. In some embodiments, the data store 120 may maintain, for each organizational tenant, an assessment cycle identifier associating each stored response, score, and compliance document with the corresponding assessment period, facilitating longitudinal tracking and comparative reporting. In some embodiments, the data store 120 may store anonymized assessment data aggregated from a plurality of organizations. For example, the anonymized assessment data may be generated by replacing organization identifiers with pseudonymous tokens using a keyed cryptographic hash function and suppressing data cells derivable from fewer than a minimum number of organizations. Such anonymized data may enable cross-organizational benchmarking and sector-segmented maturity profiles while preserving organizational confidentiality.

The first client device 104 may be any computing device (for example, a desktop workstation, laptop, mobile device, or tablet) from which a user representing an organization may access the cybersecurity assessment environment 100. In some embodiments, the first client device 104 may execute the second cybersecurity assessment system 112. The second client device 122 and the third client device 124 may each be any type of computing device and may represent additional endpoints through which additional users or organizations may access the cybersecurity assessment environment 100, illustrating the multi-device, multi-user, and multi-organization access model. Each of the client devices 104, 122, and 124 may constitute one of the computer systems of an organization, to which security improvements may be applied based on guidance summaries and completion reports generated by the cybersecurity assessment environment 100.

The first cybersecurity assessment system 106 may execute on the server system 102 as a server-side instance of the cybersecurity assessment system, and may include an assessment component 108 and a reporting component 110. In some embodiments, the first cybersecurity assessment system 106 may implement a multi-tenant architecture in which each participating organization may establish a discrete organizational account (referred to herein as a tenant) maintaining its own isolated assessment data, user roster, and organizational metadata. Assessment responses recorded by one tenant may not be accessible to other tenants, except through anonymized aggregated analytics. Within a tenant, an authorized administrator user may add additional users to contribute responses, and the system may maintain a log recording which user provided each response.

In some embodiments, a multi-tenant deployment model may enable a supervising entity (for example, a state agency or critical infrastructure protection program) to access aggregated, anonymized data across all tenants within its jurisdiction while preserving tenant-level confidentiality.

In some embodiments, initial onboarding may involve the user registering an organizational account and supplying organizational metadata comprising at least a sector classification, an organization size, and a designation indicating whether a chief information officer (CIO) or a chief information security officer (CISO) may be present. In some embodiments, the organizational metadata may additionally include a public-sector or private-sector entity designation, a cybersecurity training program status designation, and a geographic or jurisdictional identifier such as a county or municipality. In some embodiments, the sector classification may be selected from among sixteen critical infrastructure sectors defined by the applicable critical infrastructure protection authority. The organizational metadata may be used as segmentation variables in cross-organizational benchmarking and sector-level analytics.

In some embodiments, after account creation, the system may route the user directly to the active assessment and may re-engage organizations with incomplete assessments by transmitting a communication containing a hyperlink returning the user to the assessment interface at the point of prior completion.

In some embodiments, the first cybersecurity assessment system 106 may provide a home screen serving as a navigation landing page upon login, presenting controls to proceed to the active assessment and other modules.

In some embodiments, the first cybersecurity assessment system 106 may be configured to produce self-assessment outputs that are compatible with satisfying self-assessment requirements imposed on organizations by applicable statutes and regulations, including, for example, a requirement that a governmental entity adopt a recognized cybersecurity framework such as the NIST framework.

The assessment component 108 may perform core assessment workflow logic within the first cybersecurity assessment system 106, including, for example, presenting one or more assessment items for an organization. In some embodiments, the assessment items may be organized within a three-tier hierarchy comprising functional domains, subdomains within each functional domain, and individual assessment items within each subdomain of a cybersecurity assessment framework.

In some embodiments, the cybersecurity assessment framework may be the NIST Cybersecurity Framework (CSF) 2.0, drawn from NIST CSWP-29 (November 2023). The one or more functional domains may, in some embodiments, comprise Govern, Identify, Protect, Detect, Respond, and Recover (the six functions of the CSF 2.0), with subdomains and individual assessment items nested within each functional domain. For example, the Identify functional domain may include an Asset Management subdomain, which may in turn include individual assessment items such as ID.AM-01, ID.AM-02, ID.AM-03, ID.AM-04, ID.AM-05, ID.AM-07, and ID.AM-08. As another example, the Respond functional domain may include a Management subdomain, which may in turn include assessment items such as RS.MA-01 and RS.MA-03. In some embodiments, the CSF 2.0 framework may comprise a total of one hundred six (106) self-assessment items, each constituting a cybersecurity framework control item. For example, a cybersecurity framework control item for RS.MA-03 may correspond to the self-assessment question “Does your organization test its incident response plan through tabletop exercises or simulations?” Each assessment item may be associated with a control item identifier (for example, “RS.MA-03”) that may serve as the primary key for all downstream control mapping, guidance generation, workforce mapping, and benchmarking operations.

In some embodiments, the assessment items may be stored in a database table (for example, a table seeded from NIST CSWP-29 and comprising one row per assessment item, indexed by the control item identifier and annotated with the corresponding functional domain) and may be retrieved and presented to the organizational user in sequence, organized by functional domain.

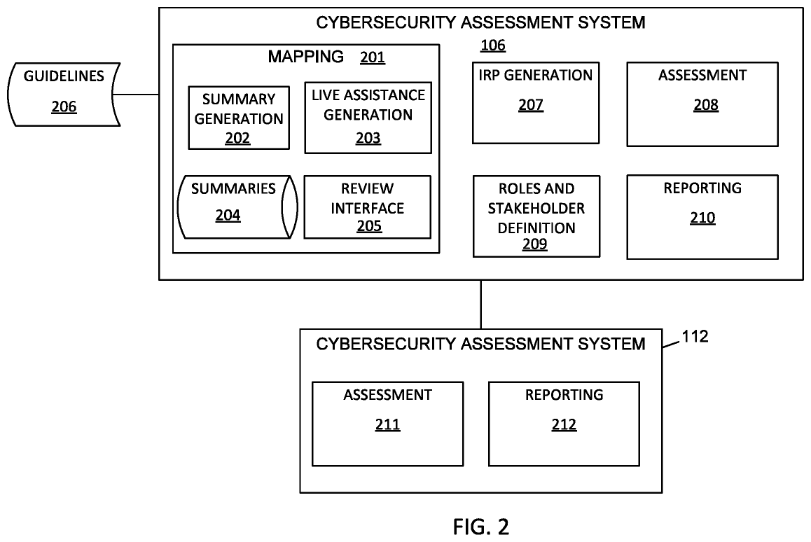

The assessment component 108 may receive one or more responses to the assessment items from the organization, each response associated with the control item identifier of the corresponding assessment item. In some embodiments, responses may be entered on a multi-level maturity scale (for example, the MS-ISAC maturity scale for SLTT organizations), as further described with respect to FIG. 2.

In some embodiments, a response may be classified as deficient based on its value relative to a defined threshold on the multi-level maturity scale. For example, a response value of 2 or below may be treated as deficient, while a value of 3 or above may be treated as compliant; the deficiency threshold may be configured differently in other embodiments. For example, for the assessment item RS.MA-03 with a response value of 1 (Not Performed), the assessment component 108 may classify the response as deficient and may initiate retrieval of corresponding controls from the security control library.

In some embodiments, a response may be received through a side-by-side modular interface in which each module may present an assessment item alongside a corresponding guidance summary and one or more plan-completion questions. In some embodiments, per-domain sub-scores may be displayed in real time as responses are recorded. In some embodiments, the user's selected maturity level response may be persisted to the data store 120 via a coupled submit-and-advance operation (for example, by activating a “Submit and Move to Next Module” control) before the interface advances to the next module, ensuring that partial assessment progress may not be lost if the session is interrupted.

The assessment component 108 may identify deficient responses and may coordinate retrieval of corresponding controls from a security control library for each deficient response, using the associated control item identifier as a retrieval key. In some embodiments, the security control library may be the NIST Special Publication 800-53 (SP 800-53) control library (for example, Revision 5, comprising approximately 1,189 controls). In some embodiments, a secondary security reference (for example, the Cross-Sector Cybersecurity Performance Goals and the Cybersecurity Risk Institute (CRI) Profile Version 2.0) may also be included.

In some embodiments, the mapping engine may maintain a pre-seeded mapping table linking each CSF 2.0 control item identifier to one or more NIST SP 800-53 control entries. For example, RS.MA-03 may map to IR-3 (Incident Response Testing) and IR-3(1) (Automated Testing).

In some embodiments, the mapping engine may also perform a second-dimension mapping operation, associating each deficient assessment item with one or more cybersecurity assistance programs, resources, or organizational points of contact capable of assisting in implementing the corresponding NIST SP 800-53 controls, and may render a selectable hyperlink to the assistance program's webpage in proximity to the guidance panel. This two-dimensional mapping may address two distinct barriers: an informational barrier (for example, the user does not know what controls apply) and a practical barrier (for example, the user does not know who can help implement those controls).

For each deficient response, the assessment component 108 may process the retrieved corresponding controls through one or more large language models (LLMs) using one or more engineered prompts to generate a guidance summary. In some embodiments, the engineered prompt may instruct the LLM to generate plain-language guidance accessible to non-expert users (for example, specifying a target reading level, maximum output length, and a required concrete first step) with the CSF 2.0 assessment item question text and concatenated control titles and descriptions as input.

In some embodiments, each guidance summary may be structured according to a multi-section template, as further described with respect to FIG. 2. For example, for RS.MA-03 where the organization responded “Not Performed,” a guidance summary may state: “Your organization does not currently test its incident response plan. Running a tabletop exercise, where your team talks through a simulated cyberattack, is an important step to determine whether your plan works. Scheduling a 2-hour tabletop exercise with IT, legal, and management within 90 days and documenting the results may significantly improve incident response readiness.” In some embodiments, LLM-generated guidance summaries may be stored with a pending-review status and may be reviewed and approved by a human analyst before being made available to any organization.

In some embodiments, the assessment component 108 may also maintain a milestone list for the organizational tenant, derived from assessment results and functioning as a continuously maintained, prioritized action-item list identifying concrete remediation steps the organization may take to improve its cybersecurity maturity.

In some embodiments, the assessment component 108 may provide access to a resource-aware AI assistant that may respond in real time to user-initiated queries about cybersecurity resources, assessment items, or related concepts, using one or more LLMs conditioned on a corpus of applicable cybersecurity guidelines. The real-time AI assistant may be distinct from the pre-generated, human-reviewed guidance summaries: guidance summaries may be batch-generated, human-reviewed, and stored for on-demand delivery, while the AI assistant may generate responses dynamically without prior human review. The system may indicate to users that AI assistant responses are generated by artificial intelligence (for example, by displaying a “(Generated by AI)” label).

The reporting component 110 may perform reporting logic within the first cybersecurity assessment system 106, including computing an aggregate maturity score and one or more functional domain sub-scores for the organization by mapping each response to a numerical value on the multi-level maturity scale. Each functional domain sub-score may be computed as the arithmetic mean of the numeric maturity response values for all answered assessment items within that domain, and the aggregate maturity score may be computed as the arithmetic mean across all assessment items. For example, domain sub-scores may be: Govern (2.80), Identify (3.10), Protect (3.40), Detect (2.60), Respond (1.90), and Recover (2.30), yielding an aggregate maturity score of approximately 2.68 on a scale of 1 to 7.

In some embodiments, the reporting component 110 may independently compute and track two distinct metrics for each functional domain: a domain completion percentage representing the proportion of answered assessment items regardless of answer value, and a domain maturity sub-score representing the arithmetic average of the maturity scale values for answered items. These metrics may be displayed together (for example, in a badge formatted as “100%|Score: 3.6” for the Govern domain). In some embodiments, the per-domain metrics may be updated and displayed in real time as the user submits each module response.

The reporting component 110 may assemble and output a completion report comprising the aggregate maturity score, functional domain sub-scores, and guidance summaries for each deficient response, organized by functional domain to enable leadership to identify the most deficient domains and review corresponding guidance coherently. In some embodiments, the completion report may be generated as a downloadable document (for example, a PDF accessible via a time-limited URL) enabling sharing with senior management, governing boards, regulators, or funding authorities without requiring the recipient to have a system account. In some embodiments, the completion report may further identify, for each deficient assessment item, one or more assistance programs or points of contact that may assist in meeting the corresponding NIST SP 800-53 controls.

In some embodiments, the reporting component 110 may generate cross-organizational benchmarking outputs by aggregating assessment data from a plurality of organizational tenants, anonymizing the data, and computing benchmark statistics using organizational metadata as segmentation variables. The benchmarking output may compare an individual organization's scores against anonymized aggregate data from organizations sharing similar metadata attributes (for example, same sector, size, and CIO/CISO designation status), returning metrics such as the segment average, the organization's own score, and its percentile rank within the segment, subject to a minimum number of participating organizations to satisfy anonymization requirements.

In some embodiments, the reporting component 110 may generate a maturity profile segmented by critical infrastructure sector, computing average aggregate maturity scores and domain sub-scores for each represented sector from anonymized assessment data. In some embodiments, the system may apply a minimum completeness threshold (for example, requiring approximately 89% of assessment items answered) before including an assessment in aggregated analytics. For example, analysis may identify the Water and Wastewater Systems sector as exhibiting the lowest average aggregate maturity score (e.g., 2.31) while the Energy sector may exhibit a higher score (e.g., 3.42) but a comparably low Respond sub-score, providing decision-makers with an evidence-based basis for prioritizing technical assistance resources.

In some embodiments, the reporting component 110 may aggregate assessment data across all participating tenants within a jurisdiction to produce a continuously updated jurisdictional risk picture (a unified view of the jurisdiction's cybersecurity maturity posture) accessible to supervising administrators and policy-makers, reflecting current organizational practices rather than a fixed point-in-time snapshot.

In some embodiments, the reporting component 110 may generate prioritized remediation advisories by cross-referencing indicators of compromise from external threat intelligence data with deficient responses from one or more organizations. An example is described with respect to FIG. 2.

In some embodiments, the reporting component 110 may generate a longitudinal progress report by retrieving prior aggregate maturity scores and domain sub-scores from prior assessment cycles stored in the data store 120, comparing them to current scores, and computing absolute and percentage change values. The longitudinal progress report may present the organization's maturity trajectory, identifying the most-improved and least-improved functional domains, supporting operationalization of cybersecurity compliance as a continuous improvement discipline.

The second cybersecurity assessment system 112 may execute on the first client device 104 as a client-side instance of the cybersecurity assessment system, communicating with the first cybersecurity assessment system 106 via the network 118. The second cybersecurity assessment system 112 may include an assessment interface component 114 and a reporting interface component 116.

The assessment interface component 114 may be a client-side component within the second cybersecurity assessment system 112 that may present assessment items and corresponding guidance summaries in a side-by-side modular interface. Each module may simultaneously display an assessment item with maturity scale response input and guidance summary in a first panel, and the corresponding plan-completion question input fields in a second panel. Navigation controls (for example, “Previous Module,” “Download Plan Templates,” and “Next Module”) may be accessible at the footer of each module view.

Plan-completion questions may be structured prompts collecting organization-specific information needed to populate a compliance document template. For example, for RS.MA-03, plan-completion questions may include “Who will review and test this plan annually? (Name and contact information)” and “Who will conduct security attack simulation exercises? (Name and contact information).” Each plan-completion question may be associated with a designated placeholder token in the compliance document template (for example, {{IRP_TEST_REVIEWER}} or {{IRP_EXERCISE_LEAD}}) so that the user's response may be automatically inserted into the corresponding field upon module submission.

The assessment interface component 114 may receive the user's responses to assessment items and plan-completion questions. In some embodiments, both the maturity scale response and plan-completion question responses for a given module may be simultaneously persisted to the data store 120 via a coupled submit-and-advance operation before the interface advances to the next module. In some embodiments, a background process may replace the corresponding placeholder token in the compliance document template with the user-supplied response text upon receipt, making an incrementally updated version available for download at any time. Placeholder tokens for unanswered questions may remain as “[Not yet provided]” until the user supplies the corresponding answer.

In some embodiments, the assessment interface component 114 may receive a user selection of a term or phrase within any text displayed in the assessment interface and may trigger generation, using one or more large language models, of a plain-language explanation of the selected term or phrase. Additional details regarding the text-selection explanation feature are described with respect to FIG. 2.

In some embodiments, the assessment interface component 114 may present, for each deficient response, one or more NICE (National Initiative for Cybersecurity Education) workforce framework roles associated with skills for remediating the deficiency, mapped from the control item identifier using a pre-seeded NICE-role mapping table. Additional details regarding workforce framework mapping and job description generation are described with respect to FIG. 2.

In some embodiments, the assessment interface component 114 may also provide access to a document panel within the organizational tenant, enabling an organizational user to upload, store, and organize files (for example, policy documents, evidence artifacts, and other records substantiating the organization's self-assessment responses) in a centralized location alongside the assessment data.

The reporting interface component 116 may be a client-side component within the second cybersecurity assessment system 112 that may display completion reports, aggregate maturity scores, functional domain sub-scores, comparative feedback reports, longitudinal progress reports, cross-organizational benchmarking outputs, NICE workforce gap analyses, milestone lists, and downloadable compliance documents (for example, an incident response plan, governance plan, or recovery plan).

In some embodiments, a compliance document generated by the cybersecurity assessment environment 100 may comprise two structural parts. A first part may provide guidance and best-practices content including a governing laws table (for example, listing Florida Statute CS/HB 7055 and NIST SP 800-61 Revision 2) together with policy statement templates, purpose statements, and definitions sections. A second part may contain organization-specific placeholder fields progressively populated by the user's plan-completion question responses as the user advances through assessment modules. Additional details regarding compliance document structure and generation are described with respect to FIG. 2.

In some embodiments, the compliance document may be available for download as the user advances through each module (for example, accessible via a “Download Plan Templates” control from each module's navigation interface) with placeholder tokens for unanswered questions displayed as “[Not yet provided]” until answered.

In some embodiments, the reporting interface component 116 may provide access to a role management portal within the organizational tenant, enabling an authorized user to define, manage, and assign personnel to standardized cybersecurity incident response and planning roles. The portal may comprise: (a) a role registry enumerating predefined roles (for example, Incident Commander/Unified Commander, Technical Lead, Operations Lead, Communications and Reporting Lead, Logistics Lead, Legal Counsel, Human Resources Representative, and Liaison Officer); (b) a role definition knowledge base providing plain-language descriptions of each role's responsibilities and authorities; (c) a personnel assignment interface for entering designated individuals' names and contact information; and (d) an auto-population mechanism that may automatically insert stored personnel assignments into corresponding placeholder fields across all applicable compliance document templates.

In some embodiments, the reporting interface component 116 may display a longitudinal progress report reflecting cumulative changes in cybersecurity maturity across one or more prior assessment cycles, including domain-level sub-scores from each cycle identifying the most-improved and least-improved domains.

In some embodiments, the reporting interface component 116 may display a comparative feedback report following a follow-up assessment cycle. Prior cycle responses may be pre-populated as default values in the follow-up cycle's assessment interface, reducing respondent burden; for items without updated responses, prior values may be carried forward to ensure complete scoring. For example, following security improvements to RS.MA-03 and GV.RM-01, updated responses of 4 (Partially Documented) and 5 (Implementation in Process) respectively may yield an updated aggregate maturity score of approximately 2.90 and a Respond domain sub-score of approximately 2.70, compared to prior scores of 2.68 and 1.90 (reflecting improvements of approximately 8.2% and 42.1% respectively), presented in a format suitable for sharing with organizational leadership.

In some embodiments, based on the completion report and guidance summaries, one or more security improvements may be applied to one or more computer systems or networks of the organization. Applying security improvements may comprise at least one of: configuring an access control (for example, enforcing multi-factor authentication); deploying a monitoring tool (for example, enabling security event logging and anomaly detection); updating a security policy; implementing an encryption protocol (for example, enforcing TLS); applying a security patch; or modifying a network configuration (for example, updating firewall rules to block known malicious IP ranges).

In some embodiments, applying security improvements may be performed through integration adapters interfacing with enterprise IT management systems (for example, identity management, cloud monitoring, document management, load balancer, patch management, or firewall management APIs). Additional details regarding security improvement logging and follow-up assessment cycles are described with respect to FIG. 2.

FIG. 2 is a block diagram illustrating the server-side cybersecurity assessment system 106 and the client-side cybersecurity assessment system 112 in expanded internal detail. The server-side system 106 may include a mapping component 201, a summary generation component 202, a live assistance generation component 203, a mapping-related data store 204, a review interface component 205, an external frameworks and standards data store 206, an IRP generation component 207, a cybersecurity assessment application 208, a roles and stakeholder definition component 209, and a reporting component 210. The client-side system 112 may include an assessment user interface 211 and a reporting user interface 212. Components 201 through 207 and 209 through 210, along with data stores 204 and 206, may execute within the cybersecurity assessment application 208. The server-side system 106 may host one or more large language models used by the summary generation component 202 and the live assistance generation component 203. The mapping component 201 may automatically correlate each deficient assessment response to one or more corresponding controls from a security control library and to one or more assistance resources, eliminating the need for manual navigation of the security control library.

The cybersecurity assessment application 208 may coordinate a cybersecurity self-assessment workflow, presenting one or more assessment items via a web-based portal. Each assessment item may correspond to a cybersecurity framework control item associated with a control item identifier (for example, RS.MA-03) that may uniquely identify the item and may serve as a primary key for all downstream operations. In one implementation, the cybersecurity assessment framework may be the NIST CSF 2.0, organized within a three-tier hierarchy of functional domains, subdomains, and individual assessment items, as described with respect to FIG. 1. The cybersecurity assessment application 208 may implement a multi-tenant organizational account model in which each organization may create its own account with one or more user accounts, and may route users directly to the assessment upon login.

In one or more implementations, the cybersecurity assessment application 208 may implement a registration workflow collecting organizational classification inputs including a public-sector or private-sector entity designation, stored as organizational metadata in the data store 120 (FIG. 1) and used to determine eligible resources and assistance offerings. After account creation, the application may route the user directly to the active assessment interface. The cybersecurity assessment application 208 may transmit re-engagement communications to organizations with incomplete assessments, each including a hyperlink returning the user directly to the assessment at the point of prior completion.

Within a tenant, an authorized administrator user may add additional users to the organizational account, each receiving access to the same active assessment. The cybersecurity assessment application 208 may maintain a log recording which user provided each assessment response, accessible to the administrator. This collaborative model may distribute the assessment task across personnel best positioned to address each functional domain.

In one or more implementations, the cybersecurity assessment application 208 may provide a home screen as a navigation landing page presenting controls for the active assessment, completion reports, document panel, milestone list, role management portal, and other modules. In an alternative implementation, the application may bypass the home screen and may route the user directly to the active assessment. The landing page behavior may be configurable or may be determined dynamically based on factors such as, for example, assessment completion status or login history.

The cybersecurity assessment application 208 may receive, via the assessment user interface 211, one or more responses including compliant and deficient responses, each associated with the corresponding control item identifier and mapped to a numerical value on the multi-level maturity scale. In one implementation, the multi-level maturity scale may be the MS-ISAC maturity scale for SLTT organizations, comprising eight selectable options: (1) Not Performed, (2) Informally Performed, (3) Documented Policy, (4) Partially Documented, (5a) Risk Formally Accepted, (5b) Implementation in Process, (6) Tested and Verified, and (7) Optimized. A risk-acceptance response (5a) may record a documented risk-acceptance determination without triggering downstream control retrieval or guidance generation. An implementation-in-progress response (5b) may be scored as a transitional maturity level. The cybersecurity assessment application 208 may identify deficient responses (for example, those at or below a defined maturity threshold such as a value of 1 or 2) and may trigger the mapping component 201 to retrieve corresponding controls and initiate guidance summary generation. Each response may be stored in association with the organization's assessment cycle identifier and the control item identifier.

The cybersecurity assessment application 208 may compute an aggregate maturity score and functional domain sub-scores by averaging the numerical response values within each domain and across all items. The application may also compute a domain completion percentage representing the proportion of answered items within each domain, independent of response value. In one implementation, the assessment user interface 211 may display both metrics together in a badge format (for example, “100%|Score: 3.6”). Both scores may be stored in the data store 120 (FIG. 1) in association with the organization's assessment cycle identifier.

The cybersecurity assessment application 208 may collect organizational metadata at account registration, including at least a sector classification (for example, from among sixteen CISA critical infrastructure sectors), an organization size, and a CIO/CISO presence designation. In some embodiments, organizations lacking a CIO or CISO may score approximately twice as low as those with such roles. The metadata may be stored in the data store 120 (FIG. 1) and may be used to contextualize maturity scores and generate benchmarking outputs.

In one or more implementations, the organizational metadata may further include: (a) a public-sector or private-sector entity type affecting eligible assistance programs and serving as a benchmarking segmentation variable; (b) a cybersecurity training program status serving as a benchmarking dimension; and (c) a geographic identifier (for example, county or municipality) enabling the reporting component 210 to generate county-level benchmarking outputs ranking participating counties by aggregate maturity score. Each metadata field may be collected via a structured input interface during registration and may be stored in the data store 120 (FIG. 1).

The cybersecurity assessment application 208 may receive external threat intelligence data comprising indicators of compromise associated with threat actors, ingested from external threat bulletin feeds (for example, FS-ISAC, government-issued bulletins) via the network 118 (FIG. 1). Each indicator of compromise record may be stored with its source feed identifier, indicator type and value, linked control item identifiers, and associated threat actor designation. The cybersecurity assessment application 208 may cross-reference indicators of compromise with deficient responses across organizations, identifying assessment gaps that may expose organizations to identified threat actors' tactics. Based on this cross-referencing, the application may generate prioritized remediation advisories identifying exposed sectors, deficient control items ranked by count of exposed organizations, and recommended immediate remediation actions. In one implementation, for example, an indicator of compromise associated with an Iranian APT actor and linked to RS.MA-03 and DE.AE-02 may trigger identification of twenty-nine exposed organizations in the Water and Wastewater Systems sector, with recommended actions including blocking indicator IP ranges, conducting tabletop exercises, and enabling anomaly detection rules.

The mapping component 201 may maintain a pre-seeded mapping table linking each control item identifier to one or more security control library entries (for example, RS.MA-03 may map to IR-3 and IR-3(1)). For each deficient response, the mapping component 201 may use the associated control item identifier to retrieve corresponding controls from the external frameworks and standards data store 206 via the mapping-related data store 204. In one implementation, the security control library may be NIST SP 800-53 Revision 5, comprising approximately 1,189 controls. The mapping component 201 may retrieve controls for all deficient responses simultaneously in a single batch query, reducing latency compared to sequential per-item lookups. Retrieved controls may be passed to the summary generation component 202.

In one or more implementations, the mapping component 201 may perform a two-dimensional mapping for each deficient assessment item. The first dimension may crosswalk the assessment item to corresponding security control library entries, producing the guidance summary. The second dimension may crosswalk the same item to specific cybersecurity assistance programs, resources, or points of contact, rendering a selectable hyperlink within the assessment user interface 211 in proximity to the guidance panel. This may address both the informational barrier (for example, what controls apply) and the practical barrier (for example, who can help implement them). The second-dimension mapping may associate items with resources from, for example, state agencies, federal agencies, ISACs, ISAOs, or commercial providers.

The external frameworks and standards data store 206 may store the security control library (for example, NIST SP 800-53 Rev. 5), the cybersecurity assessment framework (for example, NIST CSF 2.0), and other external standards (for example, CRI Profile v2.0). The mapping-related data store 204 may store pre-built mapping guidelines correlating each control item identifier to security control library entries, organized by functional domain, and may store guidance summaries generated by the summary generation component 202 and approved through the review interface component 205 for on-demand delivery. The data store 120 (FIG. 1) may persistently store assessment responses, organizational metadata, scores, prior assessment cycle data, and compliance documents for all tenants.

The summary generation component 202 may receive the corresponding controls retrieved by the mapping component 201 and may process them through one or more large language models using engineered prompts. Each prompt may instruct the model to generate plain-language guidance for small government or critical infrastructure organizations, incorporating the assessment item question text and concatenated control titles and descriptions as input. In one implementation, for example, the prompt may direct the model to act as a cybersecurity advisor writing for organizations with no cybersecurity staff, producing three to five sentences at or below tenth-grade reading level, omitting control identifiers, and including one concrete first step. The output may be a plain-language summary submitted to the review interface component 205 for human-in-the-loop review and may be stored with a pending-review status until approved.

Each guidance summary is structured according to a multi-section template comprising: (a) a plain-language remediation objective summary; (b) numbered action steps at an operational level of specificity describing how to implement the control; (c) worked examples grounding abstract control language in concrete, sector-relevant scenarios; (d) discussion questions for organizational reflection; and (e) a references section citing source control identifiers.

The summary generation component 202 may employ an assortment of contemporary large language models, enabling the system to leverage advances in model capability and to select or blend models per task. The engineered prompts may be developed through an iterative process testing candidate formulations against representative assessment items and evaluating outputs for, for example, clarity, precision, appropriate length, and structural consistency, with a human content analyst evaluating quality before production adoption.

The review interface component 205 may support human-in-the-loop review and approval of plain-language summaries produced by the summary generation component 202. A human analyst may review each summary for accuracy and relevance, may correct as needed, and may approve it, at which point it may become a guidance summary stored in the mapping-related data store 204 for on-demand delivery. Only approved summaries may be served to users; pending summaries may be withheld.

The live assistance generation component 203 may receive a user selection of a term or phrase (for example, any contiguous text string of between two and eighty characters) within any text displayed in the assessment user interface 211 (including, for example, assessment items, guidance summaries, compliance document templates, and any other visible text). In response, the component may generate a plain-language explanation using the one or more large language models, prompted to explain the term in one to two sentences without jargon. The explanation may be displayed as an overlay, tooltip, pop-up, or similar contextual element, labeled “(Generated by AI).” In one implementation, for example, selecting “tabletop exercise” may generate: “A tabletop exercise is a structured discussion where your team walks through a pretend cyberattack scenario step-by-step to practice how they would respond, without touching any real systems.” As another example, selecting “FS-ISAC” may generate an explanation identifying it as the Financial Services Information Sharing and Analysis Center and describing its role in cybersecurity information sharing. The live assistance generation component 203 may operate on demand in real time during assessment sessions.

In one or more implementations, the live assistance generation component 203 may implement a resource-aware AI assistant that may respond in real time to user queries about cybersecurity resources, assessment items, or related concepts. The resource-aware AI assistant may be distinct from guidance summaries: verified summaries may be pre-generated, human-reviewed, and stored in the mapping-related data store 204, while the AI assistant may generate responses dynamically using LLMs conditioned on the security control library, cybersecurity assessment framework, and other applicable guidelines. The text-selection explanation feature may be operable across all text content in the assessment user interface 211 without limitation to predefined glossary terms or specific interface regions.

The IRP generation component 207 may present, alongside each assessment item and guidance summary in the assessment user interface 211, one or more plan-completion questions, each associated with a placeholder token in a compliance document template. In one implementation, for example, the RS.MA-03 module may present questions asking “Who will review and test this plan annually?” (token {{IRP_TEST_REVIEWER}}) and “Who will conduct security attack simulation exercises?” (token {{IRP_EXERCISE_LEAD}}). User responses may be persisted to the data store 120 (FIG. 1) and may be updated; revised answers may replace prior stored values. The IRP generation component 207 may progressively generate a compliance document (comprising, for example, at least one of an incident response plan, governance plan, or recovery plan) by replacing placeholder tokens with user-supplied text as the user advances through modules. The compliance document may be built from a master template with a first part providing guidance, best-practices content, governing laws, and standards references, and a second part containing organization-specific placeholder fields. Unanswered fields may display as “[Not yet provided]” until answered. Completion of all one hundred six modules may yield a document approximately eighty-five percent complete, available for download in an editable format (for example, .docx) from any module.

In one or more implementations, the incident response plan template generated by the IRP generation component 207 may comprise a first part providing normative context (including, for example, a governing laws table, policy statement templates covering incident handling capability, organizational roles, incident reporting, prioritization and severity ratings, performance measures, and reporting forms, plus a purpose statement and definitions section) and a second part progressively populated with organization-specific information including incident staffing assignments, an incident notification form capturing incident facts, backup status, compromised data types, and fiscal impact, and a public information officer assignment section.

In one or more implementations, the IRP generation component 207 may extend the plan-generation function to generate a governance plan (activated by Govern-domain assessment items) addressing, for example, risk management strategy, governance structure, roles and responsibilities, cybersecurity policies, supply chain risk management, and regulatory obligations, and a recovery plan (activated by Recover-domain assessment items) addressing, for example, recovery objectives (RTO/RPO), backup procedures, restoration priorities, third-party recovery coordination, and post-incident review. Each generated plan may incorporate real-world example sections illustrating implementation by comparable organizations.

In one or more implementations, the cybersecurity assessment application 208 may provide a role management portal enabling an authorized user to define, manage, and assign personnel to standardized incident response and planning roles. The portal may comprise: (a) an extensible role registry enumerating predefined roles (for example, Incident Commander, Technical Lead, Operations Lead, Communications Lead, Logistics Lead, Legal Counsel, HR Representative, Liaison Officer); (b) a role definition knowledge base with plain-language descriptions of each role's responsibilities and authorities; (c) a personnel assignment interface for entering designated individuals; and (d) an auto-population mechanism that may insert stored assignments into corresponding placeholder fields across all compliance document templates.

The roles and stakeholder definition component 209 may map each deficient response to one or more NICE workforce framework roles using a pre-seeded mapping table linking control item identifiers to NICE occupational role identifiers and specialty areas. In one implementation, for example, a deficient response to RS.MA-03 may map to PR-CIR-001 (Cyber Defense Incident Responder) and PR-CIR-002 (Cyber Defense Analyst). The component may generate a job description template combining relevant NICE role definitions into a plain-language employment description tailored to the organization's context. In one implementation, for example, the template for a small county water authority may include a position title, reporting relationship, key responsibilities, required qualifications (for example, CompTIA Security+), and preferred certifications (for example, CySA+), generated using LLMs prompted to write in plain language with a specified output format.

The roles and stakeholder definition component 209 may generate a workforce gap analysis artifact listing, for each functional domain with deficient responses, the NICE roles required to address those deficiencies. The artifact may be formatted for presentation to non-technical stakeholders with budget authority over cybersecurity hiring. The generated job description template may be directly usable by the organization's human resources function, reducing the time and cost of translating an identified gap into a funded hiring action without requiring external consultants.

The reporting component 210 may assemble a completion report comprising the aggregate maturity score, functional domain sub-scores, and guidance summaries for each deficient response, organized by functional domain under domain headings to facilitate prioritized remediation. The completion report may be generated as a downloadable document (for example, a PDF served via a time-limited pre-signed URL) suitable for sharing with senior management, governing boards, and funding authorities. The report may identify both strengths and weaknesses across functional domains and may include, for each deficient item, an assistance program or point of contact for remediation support.

The reporting component 210 may generate cross-organizational benchmarking outputs using organizational metadata as segmentation variables, comparing an individual organization's scores against anonymized aggregate data from organizations with similar attributes. Anonymization may replace organization identifiers with pseudonymous tokens (for example, HMAC-SHA256) and may apply k-anonymity suppression (for example, suppressing cells with fewer than five organizations). The reporting component 210 may generate a maturity profile segmented by critical infrastructure sector, computing average scores for each sector from assessments meeting the minimum completeness threshold. In one implementation, for example, the Water and Wastewater Systems sector may exhibit the lowest average aggregate score (2.31) and Respond sub-score (1.74), while the Energy sector may score higher overall (3.42) but may exhibit a comparably low Respond sub-score (3.11), identifying sectors requiring targeted resources.

The reporting component 210 may provide a visualization interface, distinct from the assessment user interface 211 and reporting user interface 212, accessible to supervising administrators and policy-makers. The visualization interface may present aggregated, anonymized data in a dashboard supporting: (a) statewide aggregate maturity profiles; (b) sector-level breakdowns; (c) geographic views by county or region; (d) leadership-attribute views comparing organizations with and without CIO/CISO roles; and (e) training-program views. Assessments below a configurable minimum completeness threshold (for example, 89% of items answered) may be excluded from aggregated analytics.

The reporting component 210 may track maturity along geographic, organizational, and sector dimensions, enabling administrators to identify regions requiring prioritized assistance. The geographic segmentation may be extensible to organizational sub-units: for example, a large enterprise may define departments as sub-units completing assessments independently, with department-level maturity profiles generated analogously to sector-level profiles. All benchmarking data may be sourced exclusively from self-assessments submitted by organizational users (not from automated internet scanning or passive monitoring), providing high-integrity, first-party data. The system may support a statewide deployment model in which a supervising entity may serve as platform administrator, with the model replicable across jurisdictions.

The reporting component 210 may aggregate organizational-level data across all participating tenants to produce a unified, continuously updated jurisdictional risk picture by: (a) retrieving anonymized data for tenants meeting the completeness threshold; (b) computing aggregate scores; (c) segmenting by sector, geography, and metadata attributes; and (d) presenting segmented profiles in the visualization interface. The jurisdictional risk picture may be updated as assessments are completed or revised, and may be replicable across jurisdictions for multi-state or national benchmarking.

The reporting component 210 may retrieve prior aggregate maturity scores and domain sub-scores from prior assessment cycles stored in the data store 120 (FIG. 1), may compare them to current scores, and may compute absolute and percentage change values for each. The reporting component 210 may generate a longitudinal progress report presenting the organization's maturity trajectory, identifying the most-improved and least-improved domains. After security improvements may be applied based on guidance summaries, the cybersecurity assessment application 208 may re-present assessment items in a follow-up cycle. For items without updated responses, prior values may be carried forward to ensure complete scoring. The reporting component 210 may generate a comparative feedback report presenting current scores alongside prior scores with absolute and percentage deltas at both aggregate and domain levels, formatted for presentation to organizational leadership, governing boards, regulators, or funding authorities.

The assessment user interface 211 may present assessment items organized by functional domain, may receive maturity self-rating responses, and may display guidance summaries in a guidance panel alongside each deficient item. Each module of the side-by-side modular interface may simultaneously present the assessment item with maturity rating input and guidance panel in one panel, and plan-completion question input fields in an adjacent panel. Navigation controls (for example, “Previous Module,” “Download Plan Templates,” “Submit and Move to Next Module”) may appear at the footer of each module. The interface may implement per-module incremental submission: each response may be persisted to the data store 120 (FIG. 1) upon a coupled submit-and-navigate operation before the cybersecurity assessment application 208 advances to the next module. The compliance document may be available for download from any module, reflecting all responses provided to that point.

The side-by-side modular interface rendered by the assessment user interface 211 may implement an incentive-driven user experience model: the user may receive a tangible, downloadable deliverable as a direct consequence of engaging with assessment content. The interface may make visible the connection between answering plan-completion questions and building the compliance document, with the document growing visibly as the user advances through modules.

The reporting user interface 212 may display completion reports, scores, comparative and longitudinal reports, benchmarking outputs, maturity profiles, prioritized remediation advisories, and the progressively generated compliance document available for download in an editable format as the user advances through modules.

The organization may apply one or more security improvements to its computer systems or networks based on the guidance summaries. Applying improvements may comprise at least one of: configuring access controls, deploying monitoring tools, updating security policies, implementing encryption protocols, applying security patches, or modifying network configurations. Each applied improvement may be recorded in an improvement log storing, for example, the organization identifier, control item identifier, improvement type, timestamp, and result status. After applying improvements, the cybersecurity assessment application 208 may support a follow-up assessment cycle for generation of the comparative feedback report.

In one or more implementations, the cybersecurity assessment application 208 may provide a document panel within the organizational tenant for uploading, storing, and organizing policy documents, evidence artifacts, and other records substantiating self-assessment responses. The application may also generate and maintain a milestone list (a prioritized action-item list derived from assessment results and guidance summaries) identifying concrete remediation steps, each including, for example, an action description and associated control item identifier, transforming the completion report into a continuously maintained program management tool.

In one or more implementations, the cybersecurity assessment application 208 may be extensible to support additional assessment frameworks within the same tenant and assessment user interface 211. In one implementation, for example, the application may support a Resilience Roundtable Assessment (RRA) as an additional instrument, enabling the data store 120 (FIG. 1) to aggregate and cross-reference results from multiple frameworks for the same organization.

In one or more implementations, the cybersecurity assessment application 208 may produce self-assessment outputs compatible with self-assessment requirements imposed by applicable statutes and regulations. Because the cybersecurity assessment framework may serve as the parent framework from which most industry-specific requirements are derived, the outputs may satisfy requirements under multiple regulatory regimes. The system may not replace an external assessment but may provide a standards-based self-assessment supporting regulatory compliance. The reporting component 210 may apply the minimum completeness threshold to filter assessments used in aggregate analytics, maintaining the integrity of statewide maturity profiles and confirming the system's architecture may handle concurrent multi-tenant operation at scale.

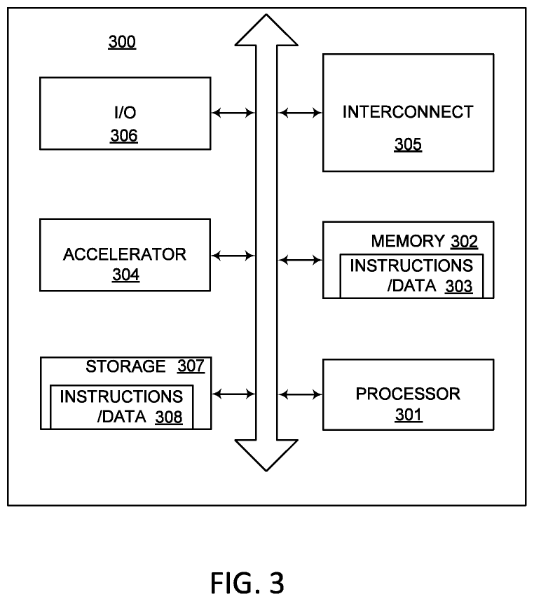

FIG. 3 is a block diagram of an example computer 300 in accordance with one or more aspects of the present disclosure. One or more computers 300 may implement any one or more of the computing devices or computing infrastructures described with respect to FIG. 1 and FIG. 2, including, for example, the server system 102, any node or server within the server system 102, the first client device 104, the second client device 122, the third client device 124, or any other computing device of the cybersecurity assessment environment 100 that executes the first cybersecurity assessment system 106, the second cybersecurity assessment system 112, or any component, module, or service described herein. In the example of FIG. 3, the computer 300 may comprise a processor 301, a memory 302, an accelerator 304, an interconnect 305, an input/output (I/O) system 306, and a storage 307.

The interconnect 305 may be a system bus, a high-speed serial interface, a switched fabric, a network-on-chip, or any other communication pathway that facilitates the transfer of data and instructions among the processor 301, the memory 302, the accelerator 304, the I/O system 306, and the storage 307. The interconnect 305 may support one or more communication protocols, such as Peripheral Component Interconnect Express (PCIe), Advanced Microcontroller Bus Architecture (AMBA), or any other point-to-point or bus-based interconnect protocol. All components of the computer 300 may communicate with each other via the interconnect 305 unless otherwise described.

The processor 301 may be one or more general-purpose microprocessors, central processing units (CPUs), microcontrollers, digital signal processors (DSPs), system-on-chip (SoC) devices, or other processing units configured to fetch, decode, and execute instructions. The processor 301 may be a single-core or multi-core processor. The processor 301 may execute software instructions retrieved from the memory 302 or the storage 307 to perform any of the functions described herein, including, for example, presenting assessment items, receiving and persisting assessment responses, retrieving security control library entries, generating and transmitting guidance summaries, computing aggregate maturity scores and functional domain sub-scores, assembling completion reports and compliance documents, generating cross-organizational benchmarking outputs, generating prioritized remediation advisories, generating longitudinal progress reports and comparative feedback reports, mapping deficient responses to NICE workforce framework roles, generating job description templates, and performing any other operation attributed to the first cybersecurity assessment system 106, the second cybersecurity assessment system 112, or any component thereof. The processor 301 may also coordinate data transfers among the memory 302, the accelerator 304, the I/O system 306, and the storage 307 via the interconnect 305.

The memory 302 may be one or more volatile or non-volatile memory devices, such as dynamic random-access memory (DRAM), static random-access memory (SRAM), synchronous DRAM (SDRAM), double data rate (DDR) DRAM, or other memory technologies. The memory 302 may serve as a primary working memory in which the processor 301 stores and retrieves data and instructions during execution. In the example of FIG. 3, the memory 302 may store instructions/data 303. The instructions/data 303 may comprise software instructions, including machine-readable instructions encoding the first cybersecurity assessment system 106, the second cybersecurity assessment system 112, the assessment component 108, the reporting component 110, the assessment interface component 114, the reporting interface component 116, the mapping component 201, the summary generation component 202, the live assistance generation component 203, the review interface component 205, the IRP generation component 207, the cybersecurity assessment application 208, the roles and stakeholder definition component 209, the reporting component 210, an operating system, one or more drivers, or other software modules, as well as data used or produced during execution of those instructions. Such data may include, for example, assessment item records, assessment response records, control item identifiers, security control library entries, pre-seeded mapping tables, engineered prompts, guidance summaries, pending-review guidance summaries, organizational metadata, aggregate maturity scores, functional domain sub-scores, domain completion percentages, prior assessment cycle scores, compliance document templates, progressively populated compliance documents, plan-completion question responses, placeholder token mappings, anonymized assessment data, cross-organizational benchmarking outputs, sector-segmented maturity profiles, indicators of compromise, prioritized remediation advisories, NICE workforce framework role mappings, job description templates, longitudinal progress reports, comparative feedback reports, and any other intermediate or final data generated during operation of the cybersecurity assessment environment 100. The memory 302 may be organized into one or more address spaces, and the processor 301 may access the instructions/data 303 via memory addressing operations performed over the interconnect 305.

The accelerator 304 may be one or more hardware accelerator units configured to perform computationally intensive operations more efficiently than the general-purpose processor 301 alone. The accelerator 304 may be a graphics processing unit (GPU), a field-programmable gate array (FPGA), an application-specific integrated circuit (ASIC), a tensor processing unit (TPU), a digital signal processing array, or any other hardware accelerator. In some examples, the accelerator 304 may perform operations arising during execution of the cybersecurity assessment environment 100, including, for example, large language model inference operations used by the summary generation component 202 and the live assistance generation component 203, batch database query operations performed by the mapping component 201, and statistical aggregation and anonymization operations performed by the reporting component 210. The accelerator 304 may access data from the memory 302 directly or via the interconnect 305, and may write results back to the memory 302 or the storage 307 upon completion of an accelerated operation. In some examples, the accelerator 304 may have its own dedicated local memory to buffer inputs and outputs during accelerated computation. In some examples, the accelerator 304 may be omitted, and the functions described herein may be performed entirely by the processor 301.

The I/O system 306 may comprise one or more input and output interfaces, ports, controllers, and devices that enable the computer 300 to exchange data with external systems, users, networks, and devices. The I/O system 306 may include one or more network interface controllers (NICs), wireless communication interfaces, universal serial bus (USB) controllers, display controllers, keyboard and pointing device interfaces, audio interfaces, serial interfaces, or other communication and peripheral interfaces. In some examples, the I/O system 306 may include one or more network interfaces that enable the computer 300 to communicate with the network 118 of FIG. 1, thereby enabling the computer 300 to transmit and receive assessment items, assessment responses, guidance summaries, compliance documents, completion reports, organizational metadata, external threat intelligence data, indicators of compromise, and other information to and from other components of the cybersecurity assessment environment 100. In some examples, the I/O system 306 may include display hardware and associated controllers that enable a user to interact with the assessment user interface 211 or the reporting user interface 212.

The storage 307 may be one or more non-volatile storage devices, such as hard disk drives (HDDs), solid-state drives (SSDs), flash memory devices, optical storage media, magnetic tape storage devices, or other persistent storage technologies. The storage 307 may provide long-term, non-volatile retention of data and instructions across power cycles of the computer 300. In the example of FIG. 3, the storage 307 may store instructions/data 308. The instructions/data 308 may comprise software instructions, including machine-readable instructions encoding any of the components described herein, as well as data that may be persisted across sessions, including, for example, assessment response records, guidance summaries, pre-seeded mapping tables, organizational metadata, aggregate maturity scores, prior assessment cycle data, compliance documents, anonymized assessment data, sector-segmented maturity profiles, prioritized remediation advisories, job description templates, longitudinal progress reports, and other persistent records generated during operation of the cybersecurity assessment environment 100. The processor 301 may load selected portions of the instructions/data 308 from the storage 307 into the memory 302 via the interconnect 305 for execution or processing. Conversely, the processor 301 may write data from the memory 302 to the storage 307 via the interconnect 305 to persist results following completion of assessment, reporting, or compliance document generation operations.

In some examples, the present disclosure encompasses a non-transitory computer-readable medium, such as the memory 302, the storage 307, or any other non-transitory computer-readable medium described herein, storing computer-executable instructions that, when executed by one or more processors, cause the one or more processors to perform any one or more of the operations described herein, including, for example: presenting one or more assessment items organized across one or more functional domains of a cybersecurity assessment framework; receiving one or more responses to the assessment items; for each deficient response, retrieving one or more corresponding controls from a security control library using a control item identifier; transmitting a guidance summary for each deficient response; computing an aggregate maturity score and one or more functional domain sub-scores; outputting a completion report; generating cross-organizational benchmarking outputs; generating a maturity profile segmented by critical infrastructure sector; generating prioritized remediation advisories; progressively generating a compliance document; mapping deficient responses to NICE workforce framework roles; generating job description templates; generating longitudinal progress reports; and generating comparative feedback reports.

In some examples, the computer 300 may also include components not separately depicted in FIG. 3, such as a power supply, a cooling system, a firmware interface, a trusted platform module (TPM), a clock generator, and one or more interrupt controllers. The computer 300 may execute an operating system that manages the processor 301, the memory 302, the accelerator 304, the I/O system 306, and the storage 307, and that provides runtime services to the first cybersecurity assessment system 106, the second cybersecurity assessment system 112, and any other application or service described herein.

In some examples, the computer 300 may be implemented in a distributed or virtualized configuration. For example, the processor 301 may be implemented as one or more virtual CPUs allocated from a physical host server, the memory 302 may be implemented as virtual machine memory, the accelerator 304 may be a virtualized GPU or FPGA resource allocated from a hardware pool, and the storage 307 may be implemented as a networked storage volume or object store. Such a virtualized implementation may support execution of the first cybersecurity assessment system 106 or the second cybersecurity assessment system 112 within a cloud computing environment, consistent with the cloud-based deployment options described with respect to the cybersecurity assessment environment 100 of FIG. 1.

Although FIG. 3 depicts a single computer 300 with specific components, the disclosure is not limited to any particular hardware configuration. In some examples, multiple computers 300 may operate in parallel, each executing a portion of the first cybersecurity assessment system 106 or the second cybersecurity assessment system 112, such that the computational workload may be distributed across a cluster of computers 300. In other examples, some components of the computer 300, such as the accelerator 304, may be omitted. In still other examples, additional accelerators 304 of different types may be present in the computer 300 and may be used in combination to perform different portions of the computation.

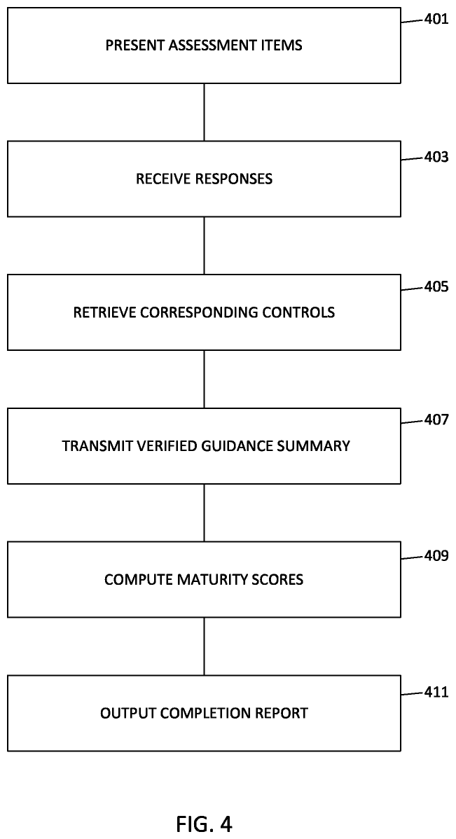

FIG. 4 is a flowchart illustrating an example method 400 for automated cybersecurity risk assessment and resource mapping in accordance with one or more aspects of the present disclosure. The method 400 may be performed, for example, by the first cybersecurity assessment system 106 executing on the server system 102, in conjunction with the second cybersecurity assessment system 112 executing on the first client device 104, as described with respect to FIGS. 1 and 2. The method 400 may be implemented as computer-executable instructions stored on a non-transitory computer-readable medium, such as the memory 302 or the storage 307 of the computer 300 described with respect to FIG. 3.

At step 402, the method 400 may comprise presenting one or more assessment items for an organization. The assessment items may be organized within a three-tier hierarchy comprising functional domains, subdomains, and individual assessment items of a cybersecurity assessment framework, for example the NIST Cybersecurity Framework (CSF) 2.0. The functional domains may comprise, for example, Govern, Identify, Protect, Detect, Respond, and Recover. Each assessment item may correspond to a cybersecurity framework control item, for example the item RS.MA-03 (“Does your organization test its incident response plan through tabletop exercises or simulations?”), and may be associated with a control item identifier (for example, “RS.MA-03”) that may serve as the primary key for all downstream operations. In some embodiments, the assessment items may be presented via a web-based portal that may route the user directly to the active assessment upon login, minimizing navigation steps.

At step 404, the method 400 may comprise receiving one or more responses to the assessment items from the organization. Each response may be associated with the control item identifier of the corresponding assessment item and may be entered on a multi-level maturity scale, for example the MS-ISAC maturity scale for State, Local, Tribal, and Territorial (SLTT) organizations. The scale may comprise eight selectable response options: 1 (Not Performed), 2 (Informally Performed), 3 (Documented Policy), 4 (Partially Documented), 5a (Risk Formally Accepted), 5b (Implementation in Process), 6 (Tested and Verified), and 7 (Optimized). Ordinal position 5 may be bifurcated into two mutually exclusive options representing fundamentally different organizational postures: a Risk Formally Accepted option (5a), indicating a deliberate governance decision not to implement the control following a risk assessment, and an Implementation in Process option (5b), indicating active but incomplete implementation. The system may treat these two postures differently in guidance generation and scoring. In some embodiments, each response may be persisted to the data store 120 via a coupled submit-and-advance operation, for example by activating a “Submit and Move to Next Module” control, before the interface advances to the next module, ensuring that partial assessment progress may not be lost if the session is interrupted.

At step 406, the method 400 may comprise, for each deficient response, retrieving one or more corresponding controls from a security control library using the control item identifier associated with the deficient response. A response may be classified as deficient based on its value relative to a defined threshold on the multi-level maturity scale, for example a response value of 2 or below. The security control library may be, for example, the NIST Special Publication 800-53 (SP 800-53) control library, comprising approximately 1,189 controls across approximately 490 to 500 pages of technical specifications. A mapping engine may maintain a pre-seeded mapping table linking each CSF 2.0 control item identifier to one or more NIST SP 800-53 control entries, for example linking RS.MA-03 to IR-3 (Incident Response Testing) and IR-3(1) (Automated Testing). In some embodiments, the mapping engine may retrieve controls for all deficient responses simultaneously in a single batch database operation, rather than performing sequential per-item lookups, thereby reducing latency and system load. In some embodiments, the cybersecurity assessment framework may be the NIST CSF 2.0 and the security control library may be the NIST SP 800-53 control library, as described with respect to Claim 2.

At step 408, the method 400 may comprise, for each deficient response, transmitting a guidance summary comprising a human-readable, interpretation of the one or more corresponding controls retrieved for that deficient response. The guidance summary may be generated by processing the retrieved controls through one or more large language models (LLMs) using one or more engineered prompts, for example prompts developed through an iterative prompt engineering process to produce guidance that is neither too long nor too verbose but is reasonably precise and accessible to users without specialized cybersecurity credentials. The LLM may generate a plain-language summary of the retrieved controls as the guidance summary, for example explaining what a deficiency in RS.MA-03 means for the organization and recommending a concrete first step such as scheduling a tabletop exercise within 90 days. Prior to transmission, each LLM-generated summary may be stored with a pending-review status and may be reviewed and approved by a human analyst before being made available to any organization, ensuring accuracy and relevance. Only summaries that have passed human review may be served to users. In some embodiments, the guidance summary may be displayed in a guidance panel alongside the corresponding assessment item.

At step 410, the method 400 may comprise computing, for the organization, an aggregate maturity score and one or more functional domain sub-scores by mapping each response to a numerical value on the multi-level maturity scale. Each functional domain sub-score may be computed as the arithmetic mean of the numeric maturity response values for all answered assessment items within that domain, for example yielding a Respond domain sub-score of 1.90 where the organization has answered all Respond-domain items at low maturity levels. The aggregate maturity score may be computed as the arithmetic mean across all assessment items, for example yielding an overall score of approximately 2.68 on a scale of 1 to 7. In some embodiments, the system may independently compute and track two distinct metrics per domain: a domain completion percentage representing the proportion of answered assessment items regardless of answer value, and a domain maturity sub-score representing the arithmetic average of the maturity scale values for answered items. These metrics may be displayed together, for example in a badge formatted as “100%|Score: 3.6” for the Govern domain. In some embodiments, the per-domain metrics may be updated and displayed in real time as the user submits each module response.

At step 412, the method 400 may comprise outputting a completion report comprising the aggregate maturity score, the one or more functional domain sub-scores, and the guidance summary for each deficient response. The completion report may organize guidance summaries by functional domain, grouping all summaries for deficient items within the same domain together under that domain heading, for example grouping all Respond-domain deficiency summaries under a “Respond” section heading. This domain-organized structure may enable organizational leadership to identify which functional domains exhibit the most deficiencies and to review all corresponding guidance in a domain-by-domain manner, facilitating prioritization of remediation efforts. The completion report may be generated as a downloadable document, for example a PDF accessible via a time-limited URL, enabling the organization to share it with senior management, governing boards, regulators, or funding authorities without requiring the recipient to have a system account.

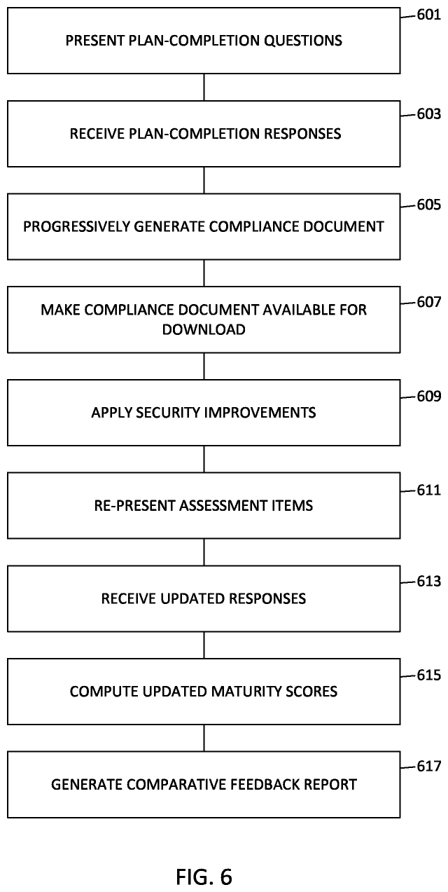

In some embodiments, the method 400 may further comprise collecting, for the organization, organizational metadata comprising at least a sector classification, an organization size, and a designation indicating whether a chief information officer (CIO) or a chief information security officer (CISO) may be present, and generating one or more cross-organizational benchmarking outputs using the organizational metadata as segmentation variables. Additional details regarding cross-organizational benchmarking and sector maturity profiling are described with respect to FIG. 6.

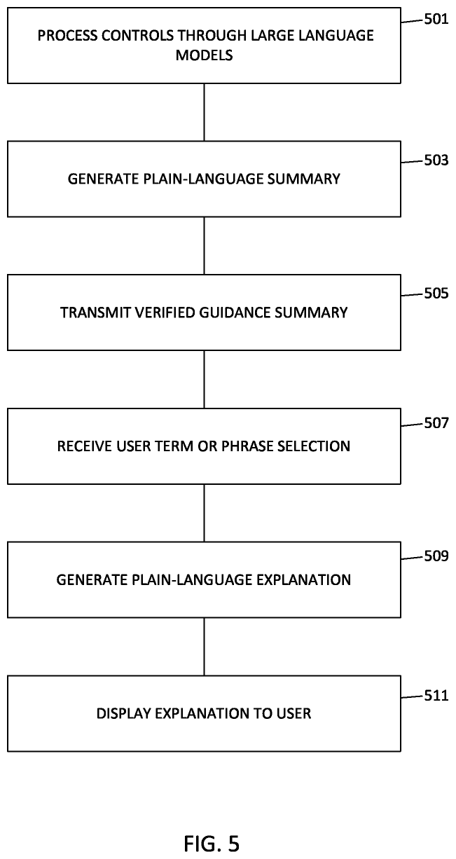

Additional details regarding threat intelligence integration and prioritized remediation advisories are described with respect to FIG. 6. Additional details regarding compliance document generation are described with respect to FIG. 5.

Additional details regarding NICE workforce framework role mapping and job description generation are described with respect to FIG. 5. Additional details regarding longitudinal progress tracking, security improvement application, and comparative feedback reports are described with respect to FIG. 6.

FIG. 5 is a flowchart illustrating an example method 500 for progressive compliance document generation and workforce gap mapping in accordance with one or more aspects of the present disclosure. The method 500 may be performed, for example, by the first cybersecurity assessment system 106 executing on the server system 102, in conjunction with the second cybersecurity assessment system 112 executing on the first client device 104, as described with respect to FIGS. 1 and 2. The method 500 may be implemented as computer-executable instructions stored on a non-transitory computer-readable medium, such as the memory 302 or the storage 307 of the computer 300 described with respect to FIG. 3. The method 500 may be performed in conjunction with the method 400 of FIG. 4, for example operating on the same assessment items, responses, and guidance summaries produced by the method 400.

At step 502, the method 500 may comprise presenting, alongside each assessment item and the corresponding guidance summary, one or more plan-completion questions. Plan-completion questions may be structured prompts that collect organization-specific information needed to populate a compliance document template. For example, for the assessment item RS.MA-03, plan-completion questions may include “Who will review and test this plan annually? (Name and contact information)” and “Who will conduct security attack simulation exercises? (Name and contact information).” Each plan-completion question may be associated with a designated placeholder token in the compliance document template, for example {{IRP_TEST_REVIEWER}} or {{IRP_EXERCISE_LEAD}}, so that the user's response may be automatically inserted into the corresponding field of the compliance document upon submission. In some embodiments, the plan-completion questions may be presented in a side-by-side modular interface, as described with respect to step 506 below.

At step 504, the method 500 may comprise receiving one or more user responses to the one or more plan-completion questions. Each user response may be associated with a specific plan-completion question and the corresponding assessment module, identified by its control item identifier, and may be persisted to the data store 120. In some embodiments, both the maturity scale response and the plan-completion question responses for a given module may be simultaneously persisted via a coupled submit-and-advance operation before the interface advances to the next module. In some embodiments, the system may support updating of prior responses, with revised answers replacing prior stored values and the compliance document updated accordingly.

At step 506, the method 500 may comprise progressively generating a compliance document based on the user responses to the one or more plan-completion questions and the plurality of assessment responses. The compliance document may comprise at least one of an incident response plan, a governance plan, or a recovery plan. The compliance document may be built from a master template comprising two structural parts: a first part providing guidance and best-practices content, including, for example, a governing laws table, policy statement templates, purpose statements, and definitions sections; and a second part containing organization-specific placeholder fields progressively populated with the user's plan-completion question responses as the user advances through assessment modules. For example, the incident response plan template may include an incident staffing section with placeholder fields for an incident commander, technical lead, operations lead, communications lead, logistics lead, legal counsel, human resources representative, and liaison officer, as well as an incident notification form and a public information officer assignment section. As the user advances through each module and provides plan-completion question responses, the system may replace corresponding placeholder tokens in the compliance document template with the user-supplied text, progressively building the document. Unanswered plan-completion question fields may retain their placeholder tokens, for example displayed as “[Not yet provided],” until the user provides the corresponding response. In some embodiments, completing all one hundred six assessment modules may yield a compliance document approximately eighty-five percent complete, with the remainder specific to the organization's particular circumstances.

At step 508, the method 500 may comprise presenting each assessment item, the corresponding guidance summary, and the corresponding one or more plan-completion questions in a side-by-side modular interface. The side-by-side modular interface may display the assessment item with maturity scale response input and guidance summary in a first panel, and the plan-completion question input fields in an adjacent second panel, within a single module view corresponding to one cybersecurity framework control item. Navigation controls, for example “Previous Module,” “Download Plan Templates,” and “Submit and Move to Next Module,” may be accessible at the footer of each module view. In some embodiments, the side-by-side modular interface may implement an incentive-driven user experience model in which the user may receive a tangible, downloadable deliverable as a direct consequence of engaging with assessment content, making visible the connection between answering plan-completion questions and building the compliance document.

At step 510, the method 500 may comprise making the compliance document available for download as the user advances through each module of the side-by-side modular interface. Beginning from the first module, the partially populated compliance document may be available for download at any point via a download control, for example a “Download Plan Templates” control in the module navigation interface. The downloaded document may reflect the current state of plan completion, with answered fields populated with the user's responses and unanswered fields represented by placeholder tokens. As the user advances through additional modules and provides further responses, subsequent downloads may reflect the incrementally completed document. In some embodiments, the compliance document may be made available in an editable format, for example a . docx file, enabling the organization to further complete and customize the document with team-specific information.

In some embodiments, the method 500 may further comprise, for each deficient response, mapping the deficient response to one or more National Initiative for Cybersecurity Education (NICE) workforce framework roles associated with skills or capabilities for remediating the deficiency. A pre-seeded mapping table may link each cybersecurity framework control item identifier to one or more NICE workforce framework occupational role identifiers and specialty areas. For example, a deficient response to RS.MA-03 may map to PR-CIR-001 (Cyber Defense Incident Responder) and PR-CIR-002 (Cyber Defense Analyst). This NICE-role mapping may identify, for each identified cybersecurity gap, who should fix it, complementing the security control library mapping that identifies what needs to be fixed.

In some embodiments, the method 500 may further comprise generating a job description template based on the one or more NICE workforce framework roles identified for each deficient response. The job description template may be produced by combining the relevant NICE role definitions, including, for example, role titles, specialty areas, key tasks, and required knowledge, skills, and abilities, into a plain-language employment description tailored to the organization's context, for example a small county government or critical infrastructure operator without dedicated cybersecurity staff. In some embodiments, the job description template may be generated using one or more large language models and may include sections for key responsibilities, required qualifications, and preferred certifications in a format suitable for direct use in a hiring process. The job description template may assist the organization in identifying the occupational roles and capabilities it needs to acquire to close the identified cybersecurity gap.

FIG. 6 is a flowchart illustrating an example method 600 for cross-organizational benchmarking, threat intelligence integration, and longitudinal maturity tracking in accordance with one or more aspects of the present disclosure. The method 600 may be performed, for example, by the first cybersecurity assessment system 106 executing on the server system 102, as described with respect to FIGS. 1 and 2. The method 600 may be implemented as computer-executable instructions stored on a non-transitory computer-readable medium, such as the memory 302 or the storage 307 of the computer 300 described with respect to FIG. 3. The method 600 may be performed in conjunction with the method 400 of FIG. 4, for example operating on the aggregate maturity scores, functional domain sub-scores, and deficient responses produced by the method 400.

At step 602, the method 600 may comprise collecting, for the organization, organizational metadata comprising at least a sector classification, an organization size, and a designation indicating whether a chief information officer (CIO) or a chief information security officer (CISO) may be present. In some embodiments, the organizational metadata may additionally include a public-sector or private-sector entity designation, a cybersecurity training program status designation, and a geographic or jurisdictional identifier. The sector classification may be selected from among, for example, sixteen critical infrastructure sectors. The organizational metadata may be stored in the data store 120 in association with the organization's assessment cycle identifier and may be used as segmentation variables in cross-organizational benchmarking and sector-level analytics. For example, analysis may reveal that organizations lacking a CIO score approximately twice as low on the maturity scale as organizations that have a CIO, and the same relationship may hold for CISO presence.

At step 604, the method 600 may comprise generating one or more cross-organizational benchmarking outputs using the organizational metadata as segmentation variables. The benchmarking outputs may compare an individual organization's aggregate maturity score and functional domain sub-scores against anonymized aggregate data from other organizations sharing similar metadata attributes, for example the same sector classification, organization size, and CIO/CISO designation status. In some embodiments, the benchmarking output may return the segment's average aggregate score, the organization's own score, and the organization's percentile rank within the segment, subject to a minimum number of participating organizations to satisfy anonymization requirements.

At step 606, the method 600 may comprise aggregating assessment data from a plurality of organizations. The aggregated assessment data may include, for each organization, the assessment responses, aggregate maturity score, functional domain sub-scores, and organizational metadata. In some embodiments, the system may apply a minimum completeness threshold, for example requiring approximately eighty-nine percent of assessment items answered, before including an assessment in aggregated analytics.

At step 608, the method 600 may comprise anonymizing the aggregated assessment data. Anonymization may replace individual organization identifiers with pseudonymous tokens, for example using a keyed cryptographic hash function, and may suppress data cells derivable from fewer than a minimum number of organizations, for example applying k-anonymity suppression. The anonymized data may be used for state-level trend analysis and reporting and may be shared with supervising entities, for example a state agency or critical infrastructure protection program, in anonymized form, ensuring that individual organizations' assessment responses and maturity scores may not be identified from the shared data.

At step 610, the method 600 may comprise generating, from the anonymized assessment data, a maturity profile segmented by critical infrastructure sector. The sector-segmented maturity profile may compute, for each represented critical infrastructure sector, the count of participating organizations, the average aggregate maturity score, and average domain sub-scores, subject to the k-anonymity threshold. For example, analysis may identify the Water and Wastewater Systems sector as exhibiting the lowest average aggregate maturity score among participating sectors, while the Energy sector may exhibit a higher overall score but a comparably low Respond domain sub-score, providing decision-makers with an evidence-based basis for prioritizing technical assistance resources.

At step 612, the method 600 may comprise receiving external threat intelligence data comprising one or more indicators of compromise associated with one or more threat actors. The external threat intelligence data may be ingested from external threat bulletin feeds, for example sector-specific information sharing and analysis centers (ISACs), information sharing and analysis organizations (ISAOs), or government-issued threat bulletins. Each indicator of compromise record may be stored with its source feed identifier, indicator type and value, linked control item identifiers, and associated threat actor designation.

At step 614, the method 600 may comprise cross-referencing the one or more indicators of compromise with deficient responses from one or more organizations. This cross-referencing may map each indicator of compromise to the cybersecurity framework control item identifiers associated with it and may identify all organizations that have deficient responses for those same control item identifiers, revealing assessment gaps that may expose organizations to the identified threat actors' tactics. The cross-referencing may span aggregated multi-organization assessment response data, enabling identification of sector-level exposure patterns. For example, an indicator of compromise associated with a nation-state threat actor and linked to RS.MA-03 may trigger identification of organizations with deficient responses for that item across one or more critical infrastructure sectors.

At step 616, the method 600 may comprise generating one or more prioritized remediation advisories based on the cross-referencing. Each prioritized remediation advisory may identify one or more critical infrastructure sectors exhibiting exposure to the one or more threat actors, the specific control item identifiers where assessed deficiencies overlap with the threat actor's indicators of compromise ranked by count of exposed organizations, and recommended immediate remediation actions, for example blocking known indicator IP ranges, conducting tabletop incident response exercises, and enabling anomaly detection rules for indicator-associated domains.

At step 618, the method 600 may comprise retrieving, for the organization, one or more prior aggregate maturity scores and one or more prior functional domain sub-scores from one or more prior assessment cycles stored in the data store 120. Prior assessment cycles may represent assessments completed by the same organization in preceding periods, for example prior annual assessment cycles, and the prior scores may be stored in association with the organization identifier and the prior cycle identifier.

At step 620, the method 600 may comprise comparing the aggregate maturity score and the one or more functional domain sub-scores computed for the current assessment cycle to the one or more prior aggregate maturity scores and prior functional domain sub-scores retrieved from the one or more prior assessment cycles. This comparison may yield delta values, for example the absolute change and the percentage change, for the aggregate maturity score and for each functional domain sub-score, identifying domains in which the organization has improved, declined, or remained flat relative to its prior assessment cycle or cycles.

At step 622, the method 600 may comprise generating a longitudinal progress report reflecting the change in cybersecurity maturity of the organization across the one or more prior assessment cycles. The longitudinal progress report may present the organization's maturity trajectory over time, including aggregate scores and domain sub-scores from each completed assessment cycle, and may identify the domains of greatest improvement and least improvement. For example, an organization may have recorded aggregate scores of 1.87, 2.11, and 2.68 across three cycles, reflecting cumulative improvement of 0.81 on the seven-point scale. The longitudinal progress report may support operationalization of cybersecurity compliance as a continuous improvement discipline rather than a one-time compliance snapshot. The longitudinal progress tracking supports an annual assessment cadence with automated re-engagement of organizational users, enabling organizations to demonstrate measurable, incremental progress toward cybersecurity maturity goals over successive cycles to governing boards, regulators, or funding authorities.

In some embodiments, the method 600 may further comprise applying, to one or more computer systems or networks of the organization, one or more security improvements based on the guidance summaries produced by the method 400. Applying the one or more security improvements may comprise at least one of: configuring an access control, for example enforcing multi-factor authentication; deploying a monitoring tool, for example enabling security event logging and anomaly detection; updating a security policy; implementing an encryption protocol, for example enforcing Transport Layer Security (TLS); applying a security patch to one or more software components; or modifying a network configuration, for example updating firewall rules to block known malicious IP ranges.

In some embodiments, the method 600 may further comprise, after applying the one or more security improvements, re-presenting the one or more assessment items to the organization to initiate a follow-up assessment cycle. Prior cycle responses may be pre-populated as default values in the follow-up cycle's assessment interface, reducing respondent burden by requiring the organization to update only those responses reflecting changed practices. The method 600 may receive updated responses to the re-presented assessment items, compute, from the updated responses, an updated aggregate maturity score and updated functional domain sub-scores using the same methodology as the prior cycle, and generate a comparative feedback report reflecting the change in cybersecurity maturity of the organization between the prior aggregate maturity score and the updated aggregate maturity score. The comparative feedback report may present the before-and-after maturity scores at both the aggregate level and the functional domain level, including the absolute delta and percentage change for each domain and for the overall aggregate score, in a format suitable for sharing with organizational leadership, governing boards, regulators, or funding authorities.

As used herein, “comprising” and variations thereof (such as “comprises,” “includes,” and “including”) are open-ended and do not exclude additional elements or steps. References to an element in the singular do not exclude the plural, and references in the plural do not exclude the singular.

As used herein, the term “may” indicates a permissive or optional aspect and does not impose a requirement unless context clearly requires otherwise.

As used herein, “large language model” or “LLM” refers to any neural network-based generative model trained on a text corpus to produce natural-language outputs, including transformer-based models, fine-tuned models, and model ensembles. The disclosure is not limited to any particular model architecture or provider.

Numerical values described herein as “approximately,” “about,” or “roughly” are engineering approximations and may vary as would be understood in the relevant technical context.

The various components and functions described herein may be implemented in hardware, software, firmware, or any combination thereof, and may be distributed across one or more computing devices, microservices, or modules, unless otherwise expressly stated.

The embodiments described herein are examples only. The scope of the disclosure is defined by the claims, not by any particular described embodiment. Features described in separate embodiments may be combined unless such combination is expressly excluded or would be technically infeasible.

1. A method, comprising:
presenting one or more assessment items for an organization, the assessment items organized across one or more functional domains of a cybersecurity assessment framework, each assessment item corresponding to a cybersecurity framework control item of the cybersecurity assessment framework and associated with a control item identifier;
receiving one or more responses to the assessment items including compliant responses and deficient responses, each response associated with the control item identifier of the corresponding assessment item;
for each deficient response, retrieving one or more corresponding controls from a security control library using the control item identifier corresponding to the deficient response;
for each deficient response, transmitting a guidance summary comprising a human-readable interpretation of the one or more corresponding controls retrieved for the deficient response;
computing, for the organization, an aggregate maturity score and one or more functional domain sub-scores, each functional domain sub-score corresponding to a respective one of the one or more functional domains, by mapping each response of the one or more responses to a numerical value on a multi-level maturity scale; and
outputting a completion report comprising the aggregate maturity score, the one or more functional domain sub-scores, and the guidance summary for each deficient response.

2. The method of claim 1, wherein the cybersecurity assessment framework is the NIST Cybersecurity Framework (CSF) 2.0, the one or more functional domains comprises Govern, Identify, Protect, Detect, Respond, and Recover, and the security control library is the NIST Special Publication 800-53 control library.

3. The method of claim 2, wherein retrieving the one or more corresponding controls comprises retrieving controls for each of a plurality of the deficient responses simultaneously; the method further comprising organizing the guidance summaries in the completion report by functional domain, grouping the guidance summaries for deficient responses within the same functional domain together.

4. The method of claim 1, further comprising generating the guidance
summary for each deficient response by:
processing the one or more corresponding controls retrieved for the deficient response through one or more large language models using one or more engineered prompts to generate a candidate plain-language summary;
generating, as the guidance summary, a plain-language summary of the one or more corresponding controls;
receiving, through the review interface, an approval, rejection, or modification of the candidate plain-language summary; and
designating the approved or modified candidate plain-language summary as the guidance summary for transmission to the organization.

5. The method of claim 4, further comprising:
receiving a user selection of a term or phrase within one or more of the assessment items or the guidance summaries; and
generating, using the one or more large language models, a plain-language explanation of the selected term or phrase and displaying the plain-language explanation as an overlay, a tooltip, a pop-up, an inline annotation, a sidebar panel, or a highlighted callout.

6. The method of claim 1, further comprising:
collecting, for the organization, organizational metadata comprising at least a sector classification, an organization size, and a designation indicating whether a chief information officer or a chief information security officer is present; and
generating one or more cross-organizational benchmarking outputs using the organizational metadata as segmentation variables.

7. The method of claim 6, further comprising:
aggregating assessment data from a plurality of organizations;
anonymizing the aggregated assessment data; and
generating, from the anonymized assessment data, a maturity profile segmented by critical infrastructure sector.

8. The method of claim 1, further comprising:
receiving external threat intelligence data comprising one or more indicators of compromise associated with one or more threat actors;
cross-referencing the one or more indicators of compromise with the deficient responses from one or more organizations; and
generating one or more prioritized remediation advisories based on the cross-referencing, the one or more prioritized remediation advisories identifying one or more sectors exhibiting exposure to the one or more threat actors.

9. The method of claim 1, further comprising:
presenting, alongside each assessment item and the corresponding guidance summary, one or more plan-completion questions;
receiving one or more user responses to the one or more plan-completion questions; and
progressively generating a compliance document based on the user responses to the one or more plan-completion questions and the plurality of responses, the compliance document comprising at least one of an incident response plan, a governance plan, or a recovery plan.

10. The method of claim 9, further comprising:
wherein presenting each assessment item comprises displaying the assessment item, the corresponding guidance summary, and the corresponding one or more plan-completion questions in a side-by-side modular interface; and
making the compliance document available for download as the user advances through each module of the side-by-side modular interface.

11. The method of claim 1, further comprising:
for each deficient response, mapping the deficient response to one or more National Initiative for Cybersecurity Education (NICE) workforce framework roles associated with skills or capabilities for remediating the deficient response; and
generating a job description template based on the one or more NICE workforce framework roles.

12. The method of claim 1, further comprising:
retrieving, for the organization, one or more prior aggregate maturity scores and one or more prior functional domain sub-scores from one or more prior assessment cycles;
comparing the aggregate maturity score and the one or more functional domain sub-scores to the one or more prior aggregate maturity scores and the one or more prior functional domain sub-scores; and
generating a longitudinal progress report reflecting a change in cybersecurity maturity of the organization across the one or more prior assessment cycles.

13. The method of claim 1, further comprising:
applying, to one or more computer systems or networks of the organization, one or more security improvements based on the guidance summaries, wherein applying the one or more security improvements comprises at least one of: configuring an access control, deploying a monitoring tool, updating a security policy, implementing an encryption protocol, applying a security patch, or modifying a network configuration.

14. The method of claim 13, further comprising:
after applying the one or more security improvements, re-presenting the one or more assessment items to the organization;
receiving updated responses to the one or more assessment items;
computing, from the updated responses, an updated aggregate maturity score and updated functional domain sub-scores; and
generating a comparative feedback report reflecting a change in cybersecurity maturity of the organization between the aggregate maturity score and the updated aggregate maturity score.

15. A computer readable medium storing executable instructions to:
present one or more assessment items for an organization, the assessment items organized across one or more functional domains of a cybersecurity assessment framework, each assessment item corresponding to a cybersecurity framework control item of the cybersecurity assessment framework and associated with a control item identifier;
receive one or more responses to the assessment items including compliant responses and deficient responses, each response associated with the control item identifier of the corresponding assessment item;
for each deficient response, retrieve one or more corresponding controls from a security control library using the control item identifier corresponding to the deficient response;
for each deficient response, transmit a guidance summary comprising a human-readable interpretation of the one or more corresponding controls retrieved for the deficient response;
compute, for the organization, an aggregate maturity score and one or more functional domain sub-scores, each functional domain sub-score corresponding to a respective one of the one or more functional domains, by mapping each response of the one or more responses to a numerical value on a multi-level maturity scale; and
output a completion report comprising the aggregate maturity score, the one or more functional domain sub-scores, and the guidance summary for each deficient response.

16. The computer readable medium of claim 15, wherein the instructions further cause generation of the guidance summary for each deficient response by:
processing the one or more corresponding controls retrieved for the deficient response through one or more large language models using one or more engineered prompts to generate a candidate plain-language summary;
generating, as the guidance summary, a plain-language summary of the one or more corresponding controls;
receiving, through a review interface, an approval, rejection, or modification of the candidate plain-language summary; and
designating the approved or modified candidate plain-language summary as the guidance summary for transmission to the organization.

17. The computer readable medium of claim 15, wherein the instructions further cause:
collecting, for the organization, organizational metadata comprising at least a sector classification, an organization size, and a designation indicating whether a chief information officer or a chief information security officer is present; and
generating one or more cross-organizational benchmarking outputs using the organizational metadata as segmentation variables.

18. The computer readable medium of claim 15, wherein the instructions further cause:
receiving external threat intelligence data comprising one or more indicators of compromise associated with one or more threat actors;
cross-referencing the one or more indicators of compromise with the deficient responses from one or more organizations; and
generating one or more prioritized remediation advisories based on the cross-referencing, the one or more prioritized remediation advisories identifying one or more sectors exhibiting exposure to the one or more threat actors.

19. The computer readable medium of claim 15, wherein the instructions further cause:
presenting, alongside each assessment item and the corresponding guidance summary, one or more plan-completion questions;
receiving one or more user responses to the one or more plan-completion questions; and
progressively generating a compliance document based on the user responses to the one or more plan-completion questions and the plurality of responses, the compliance document comprising at least one of an incident response plan, a governance plan, or a recovery plan.

20. A system, comprising:
a processor;
a memory coupled to the processor and storing instructions executable by the processor to:
present one or more assessment items for an organization, the assessment items organized across one or more functional domains of a cybersecurity assessment framework, each assessment item corresponding to a cybersecurity framework control item of the cybersecurity assessment framework and associated with a control item identifier;
receive one or more responses to the assessment items including compliant responses and deficient responses, each response associated with the control item identifier of the corresponding assessment item;
for each deficient response, retrieve one or more corresponding controls from a security control library using the control item identifier corresponding to the deficient response;
for each deficient response, transmit a guidance summary comprising a human-readable interpretation of the one or more corresponding controls retrieved for the deficient response;
compute, for the organization, an aggregate maturity score and one or more functional domain sub-scores, each functional domain sub-score corresponding to a respective one of the one or more functional domains, by mapping each response of the one or more responses to a numerical value on a multi-level maturity scale; and
output a completion report comprising the aggregate maturity score, the one or more functional domain sub-scores, and the guidance summary for each deficient response.
